(19) United States
(12) Patent Application Publication
(10) Pub. No.: US 2024/0152332 A1
(43) Pub. Date: May 9, 2024

(54) METHOD FOR APPROXIMATIVELY DETERMINING A SCALAR PRODUCT USING A MATRIX CIRCUIT

(71) Applicant: Robert Bosch GmbH, Stuttgart (DE)

(72) Inventors: Cecilia Eugenia De La Parra Aparicio, Herrenberg (DE); Andre Guntoro, Weil Der Stadt (DE); Taha Soliman, Renningen (DE)

(21) Appl. No.: 18/500,210

(22) Filed: Nov. 2, 2023

(30) Foreign Application Priority Data
Nov. 8, 2022 (DE) 10 2022 211 802.2

(51) Int. Cl. G06F 7/78; G06F 7/499

(52) U.S. Cl. CPC G06F 7/78; G06F 7/49942

(57) ABSTRACT

A method for approximatively determining at least one scalar product of at least one input vector with a weight vector. Input components of the input vector and weight components of the weight vector are present in binary form. At least one matrix circuit is used, wherein the memory cells are programmed according to bits of the weight components. Bits with the same significance of at least a portion of the weight components are respectively programmed in memory cells of the same column. For each of one or more subsets of the input components, a bit sum determination is carried out. To a corresponding subset of the row lines, voltages are applied according to bits with the same significance of the respective subset of the input components and a limited bit sum is determined as the output value of the respective analog-to-digital converter.

### CROSS REFERENCE

The present application claims the benefit under 35 U.S.C. § 119 of German Patent Application No. DE 10 2022 211 802.2 filed on Nov. 8, 2022, which is expressly incorporated herein by reference in its entirety.

### FIELD

The present invention relates to a method for approximatively determining a scalar product of an input vector and a weight vector using a matrix circuit, and to a matrix circuit.

### BACKGROUND INFORMATION

In many computationally intensive tasks, in particular in artificial intelligence applications or in machine learning applications that use neural networks, the determination of scalar products of vectors is required. For example, the convolutions in a “convolutional neural network,” hereinafter referred to as CNN, are scalar products of vectors. In order to carry out such vector operations quickly and efficiently, vector matrix multipliers in the form of circuits specifically provided for this purpose can be used.

In these vector matrix multipliers, which are also referred to as “dot product engines,” a vector of input voltages is converted into a vector of output voltages by means of a matrix-like array of memristors, which are arranged at crossing points of lines running orthogonally to one another, and which connect the crossing lines in pairs, wherein the output voltages are each proportional to the scalar product (“dot product”) of the vector of the input voltages with the conductivities of the memristors arranged in a column. The input voltages are in this case applied to the row lines running in one direction, and result in currents via the memristors into the column lines which run orthogonally thereto and are connected to a ground potential. The currents are converted into the output voltages by means of transimpedance amplifiers. Such circuits can reach sizes of in each case a few 100 or 1000 rows and columns.

German Patent Application No. DE 10 2020 211 818 A1 shows a scalar product circuit for calculating a binary scalar product of an input vector with a weight vector, and an associated method. The scalar product circuit comprises one or more adders and at least one matrix circuit with memory cells that are arranged in a plurality of rows and a plurality of columns in a matrix-like manner and respectively have a first and a second memory state. Each matrix circuit has at least one weight region with one or more bit sections, wherein the matrix circuit has an analog-to-digital converter and a bit shift unit connected thereto, for each bit section, wherein the column lines of the bit section are connected to the analog-to-digital converter, and wherein a column selection switch element is provided for each column. The bit shift units are connected to one of the adders, wherein those bit shift units that are comprised in a weight region are respectively connected to the same adder.

### SUMMARY

According to the present invention, a method for approximatively determining a scalar product of an input vector and a weight vector, and a matrix circuit are provided. Advantageous example embodiments of the present invention are disclosed herein.

An example embodiment of the present invention takes the measure of using a matrix circuit for approximatively determining a scalar product of an input vector with a weight vector, the column lines of said matrix circuit being connected to respective analog-to-digital converters, which have a precision that is less than the number of memory cells in the corresponding column. In this case, the memory cells are programmed according to bits of the weight components of the weight vector and, for each of one or more subsets of the input components of the input vector, a bit sum determination is carried out, wherein, to a corresponding subset (corresponding to the respective subset of the input components) of the row lines, voltages are applied according to bits with the same significance of the respective subset of the input components, and a limited bit sum is determined as the output value of the respective analog-to-digital converter, which limited bit sum has significances corresponding to the significance of the respective column and to the significance of the bits to which the applied voltages correspond. An approximation for the scalar product is determined as a sum of the limited bit sums weighted according to their significances. The bit sum is in this case limited to the highest value that the analog-to-digital converter can output (i.e., the precision of the analog-to-digital converter). In particular for algorithms, for example in the field of machine learning, this makes it possible to use analog-to-digital converters with relatively few bits, which results, for example, in a lower area consumption and energy consumption of corresponding analog-to-digital converter circuits.

The (overall) significance of a bit sum results as the sum of the significance of the column (i.e., the corresponding bits of the weight components; index r in the description of FIG. 2) and the significance of the bits according to which the voltages are applied (i.e., the corresponding bits of the input components; index p in the description of FIG. 2).

In one example embodiment of the present invention, the one or more subsets of the input components are selected such that, for each subset, the number of input components included therein is equal to or less than an assigned activation number of at least one predetermined maximum activation number. The difference between the maximum activation number and the precision of the respective analog-to-digital converter indicates how large an error possibly occurring in the approximation can be.

In one example embodiment of the present invention, the at least one predetermined maximum activation number is selected based on a predetermined approximation level of the scalar product and/or based on a plurality of predetermined approximation levels which are assigned to different portions of the scalar product. An approximation level (e.g., as a value in a discrete or continuous value range) in principle indicates how accurate or inaccurate the approximation should be. The respective maximum activation number is determined to be the smaller, the more accurate the approximation is to be. A maximum activation number, which is equal to the precision of the respective analog-to-digital converter, corresponds to a precise determination of the scalar product, i.e., an approximation that is with certainty without errors. If a different approximation level is assigned to different ranges of the scalar product (i.e., different ranges of the input vector or weight vector or corresponding component ranges), the predetermined maximum activation number for subsets is in particular selected according to a component range that overlaps them; for example, if a subset intersects with a plurality of component ranges, the smallest of the corresponding activation numbers.

The one or more subsets of the input components are expediently disjunct. The union of the one or more subsets is also equal to the entire set of input components, i.e., the entire set of the input components is divided in order to obtain the one or more subsets. The term “subset of the input components” is to be understood such that, in the case of only one subset, the subset can be equal to the entire set of input components.

A circuit according to an example embodiment of the present invention has at least one matrix circuit and one control circuit, wherein the at least one matrix circuit has memory cells which are arranged in a plurality of rows and a plurality of columns in a matrix-like manner and respectively have a first and a second memory state, wherein the matrix circuit has a row line for each row and a column line for each column, wherein each memory cell is connected to a row line and a column line and is configured to conduct an electrical current into the column line connected to the memory cell, wherein a current intensity of the current depends on a voltage applied to the row line connected to the memory cell and on the memory state of the memory cell, wherein the current intensity is below a particular current intensity limit if a voltage of zero is applied and/or if the memory cell is in the first memory state, and wherein the current intensity has a defined current intensity value if the applied voltage has a non-zero predetermined voltage value and the memory cell is in the first memory state. Each column line is connected to an analog-to-digital converter that has a precision that is less than the number of memory cells in the corresponding column. The control circuit is configured to program the memory cells and to apply voltages to the row lines.

Further advantages and embodiments of the present invention can be found in the description and the figures.

The present invention is illustrated schematically in the figures on the basis of exemplary embodiments and is described below with reference to the figures.

### BRIEF DESCRIPTION OF THE DRAWINGS

FIGS. 1A and 1B show the functional principle of a vector matrix multiplier.

FIG. 2 illustrates a binary scalar multiplication of two vectors by means of a matrix circuit.

FIG. 3 shows an exemplary structure of a memory cell comprising a field-effect transistor which has different memory states.

FIG. 4 shows a flowchart according to an exemplary embodiment of the approximative determination of a scalar product, according to the present invention.

### DETAILED DESCRIPTION OF EXAMPLE EMBODIMENTS

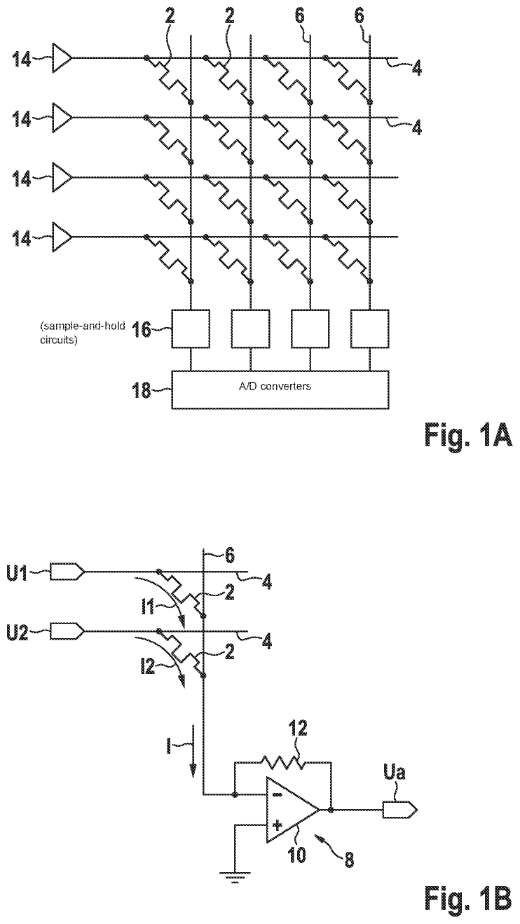

FIGS. 1A and 1B illustrate the functional principle of a vector matrix multiplier, also referred to as matrix circuit or “dot product engine.” The vector matrix multiplier comprises memory cells in the form of memristors 2 arranged in rows and columns in a matrix-like manner. The number of rows and the number of columns are in each case arbitrary, wherein a 4×4 array is shown by way of example. The memory function of the memristors results from the fact that the resistance of the memristors can be set by applying a programming voltage.

The vector matrix multiplier furthermore comprises a row line 4 for each row of the matrix-like array and a column line 6 for each column. The memristors 2 are arranged at the crossing points of the row lines and column lines running perpendicular to one another, and respectively connect a row line to a column line, which are not connected otherwise.

If voltages are applied to the row lines, currents flow from the row lines 4 through the memristors 2 into the column lines 6. This is illustrated for a column and two rows in FIG. 1B. There, a voltage U1 is applied to one of the row lines, and a voltage U2 is applied to the other. The current I1 through one of the memristors is determined by the conductivity G1 thereof: I1=G1·U1; the current I2 through the other memristor, the conductivity of which is G2, is correspondingly I2=G2·U2. The sum of the currents, i.e., the total current I=I1+I2=G1·U1+G2·U2, then flows through the column line 6. A multiplication of the voltages U1, U2, considered as a vector, at the row lines 4 thus takes place with the conductivities G1, G2, considered as a vector, of the memristors in one column, wherein the total current is proportional to the result of this vector product. Based on the entire matrix array, a multiplication of the vector of the voltages with the conductivities, considered as matrix elements, of the memristors thus takes place in principle.

The total current of each column can, for example, be converted into an output voltage Ua by means of a transimpedance amplifier 8 (see FIG. 1B). The transimpedance amplifier 8, which is shown here by way of example and is conventional, comprises an operational amplifier 10, whose inverting input is connected to the column line and whose non-inverting input is connected to ground, and a resistor 12 via which the operational amplifier receives negative feedback, so that the output voltage Ua is given as Ua=−R·I, wherein R is the resistance value of the resistor 12. At the inverting input of the operational amplifier 10, the transimpedance amplifier 8 generates a so-called virtual ground, which, due to the high open-loop gain of the operational amplifier (e.g., 100,000), differs only slightly (e.g., only approximately 50 μV if the voltages U1, U2 are in the range of approximately 5 V) from the ground potential so that, in terms of circuitry, the ground potential (i.e., the virtual ground) is applied to the end of the column line, as required for the function of the circuit.

The voltages at the row lines are typically generated from digital signals by means of digital-to-analog converters 14. Likewise, the output voltages at the column lines, i.e., the voltages Ua generated by the transimpedance amplifiers, are typically again converted into a digital signal by means of sample-and-hold elements 16 (sample-and-hold circuits) and analog-to-digital converters 18. The sample-and-hold elements 16 can be integrated in the analog-to-digital converter 18 or in the analog-to-digital converters 18.

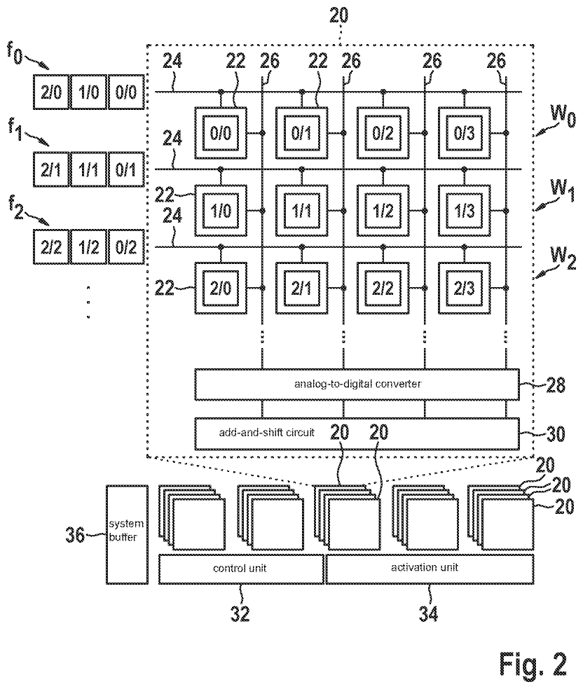

Due to the analog-to-digital converters, a considerable area requirement on the chip on which the vector matrix multiplier is implemented, and a considerable energy requirement during operation can arise. The area requirement and energy requirement associated with the analog-to-digital conversion can in each case be in the range of approximately 30-60% of the total area requirement or of the total energy requirement of the circuit. FIG. 2 illustrates a binary scalar multiplication of two vectors by means of a matrix circuit 20.

In principle, the matrix circuit 20 corresponds to the vector matrix multiplier of FIGS. 1A, 1B, wherein the memory cells 22, which are respectively connected to a row line 24 and a column line 26, only assume two different states (or are operated accordingly), namely a state with high resistance (also referred to as the first memory state) and a state with low resistance (also referred to as the second memory state). In this case, the resistance value of the high resistance is the same at least for all memory cells of each column, and the resistance value of the low resistance is likewise the same at least for all memory cells of each column. Expediently, the resistance value of the high resistance is the same for all memory cells, and the resistance value of the low resistance is the same for all memory cells. The two resistance values substantially correspond to a conductive or a non-conductive state, wherein the on/off ratio should be as large as possible. When memristors are used as in FIG. 1, the greatest possible resistance value and a smallest possible resistance value can be used, for example. In the case of memristors, an on/off ratio of more than 10⁴ is possible, for example. For a given non-zero voltage, the ratio of the current intensities corresponds to the on/off ratio; for example, in the state with high resistance, the current intensity can be below a predetermined current intensity limit, and in the state with low resistance, it can be above the predetermined current intensity limit by a multiple, e.g., at least 10³, 10⁴ or 10³.

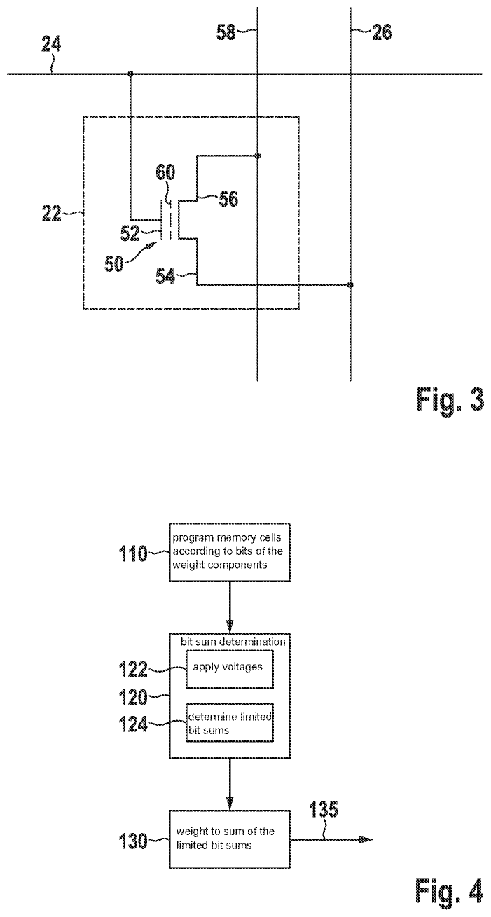

Instead of or in addition to resistors (e.g., memristors), the memory cells can respectively have a semiconductor switch element (e.g., a transistor, for example a metal oxide field-effect transistor), which has a settable or programmable threshold voltage (e.g., FeFET, ferroelectric field-effect transistor). In this embodiment, the control terminal (gate terminal) of the semiconductor switch elements is connected to the respective row line 24, and the source terminal is connected to the respective column line 26. The drain terminals are connected to voltage or power supply lines, which are connected to a voltage or power source (see FIG. 3). If the voltage at the row line is below the set threshold voltage, no current or a very low current, which is below a predetermined current intensity limit, flows. If the voltage at the row line is above the set threshold voltage, a defined current (the intensity of which is above the predetermined current intensity limit by a multiple, e.g., at least 10³, 10₄ or 10⁵) flows through the semiconductor switch element into the corresponding column line. A high threshold voltage corresponds to the state with high resistance or the first memory state, and a low threshold voltage corresponds to the state with low resistance or the second memory state.

The programming of the memory cells, i.e., the setting or programming of particular memory states of the memory cells, can take place in all cases (memristors, semiconductor switch elements, . . . ) by applying programming voltages (which are typically higher than voltages used during reading). For this purpose, the row lines or column lines shown and/or separate programming lines (not shown) can be used.

If field-effect transistors (FET) with different memory states are used, in particular FeFETs or FGMOSs, a power supply line, which is connected to a power source or voltage supply, can be provided for each column in addition to the column line. FIG. 3 shows an exemplary structure of a corresponding memory cell 22: The row line 24 is connected to the gate 52 of the FET 50, the source terminal 54 of the FET 50 is connected to the column line, and the drain terminal 56 of the FET 50 is connected to the power supply line 58 of the column. A corresponding material layer 60 of the FET 50 serves as a memory for the memory states; reference sign 60 relates to the ferroelectric layer in a FeFET or the floating gate in an FGMOS. Memory states (polarization in a FeFET, charge in the floating gate in an FGMOS) are then determined as follows: In the first memory state, the drain-source path is non-conductive, irrespective of whether a voltage of 0 V or a voltage with the predetermined voltage value (e.g., 5 V) is applied; in the second memory state, the drain-source path is non-conductive if a voltage of 0 V is applied, and conductive if the predetermined voltage value is applied, wherein the current intensity of the current is the same for different FETs.

The two states can be regarded as a bit; for example, the state with high resistance can be interpreted as a bit with value 0 and the state with low resistance can be interpreted as a bit with value 1.

Accordingly, it is provided to apply only voltages with two different defined levels to the row lines 24; e.g., 0 V and a non-zero voltage U_{def} V. One level (0 V in the example) can be interpreted as a bit with value 0, and the other level (U_{def} V in the example) can be interpreted as a bit with value 1. With these interpretations, a logical AND operation respectively takes place in the memory cells. Depending on the result, no current I=0 A flows (or practically equal to 0 A or below the predetermined current intensity limit) or a current of defined intensity I=I_{def} (defined current intensity value) flows from the memory cells into the column lines. The total current intensity on a column line is accordingly (due to the high on/off ratio) I_{ges}=n·I_{def}, wherein n is the number of memory cells on the column line that conduct the current of defined intensity into the column line. As described for FIGS. 1A, 1B, the total current intensity can be converted into a voltage and can be converted by means of a suitable analog-to-digital converter into a binary number which is equal to the number n (the conversion of the current into the voltage takes place in particular such that current intensity steps n·I_{def} are mapped to corresponding voltage steps that can be distinguished by the analog-to-digital converter). An analog-to-digital converter 28 can be provided for each column line.

The scalar product g=Σᵢfᵢ·wᵢ of an input vector f=(f₀, f₁, . . . , f_{D-1}) and a weight vector w=(w₀, w₁, . . . , w_{D-1}) can be calculated binarily, i.e., binary representations for the components of the input vector and the components of the weight vector are used:

$${f}_{i} = {\sum }_{p = 0}^{P} {f}_{pi} {2}^{p}$$

$${w}_{i} = {\sum }_{r = 0}^{q} {w}_{ir} {2}^{r}$$

fₚᵢ and wᵢᵣ represent bits and can respectively assume the values 0 or 1. Here, P is the accuracy (P+1: number of bits) of the components of the input vector, and q is the accuracy (q+1: number of bits) of the components of the weight vector. The indices p and r correspond to the significance or valency of the respective bits. The components of the input vector are also referred to as input components, and the components of the weight vector are also referred to as weight components.

The bits fₚᵢ of the components f₀, f₁, f₂, . . . of the input vector are shown to the left in the figure for 3 bits (P=2), for example, wherein the notation “p/i” is used for fₚᵢ. The most significant bit is thus to the far left.

The bits wᵢᵣ of the components w₀, w₁, w₂, . . . of the weight vector are shown in the memory cells 22 for 4 bits (q=3), for example, wherein the notation “i/r” is used for wᵢᵣ. The most significant bit is thus to the far right. The memory cells 22 are programmed according to the bit values. Typically, the scalar product of the same weight vector, or in more general terms, of the same weight matrix, with a plurality of different input vectors is determined so that the memory cells need not be re-programmed for each scalar product formation.

In both cases, different columns or positions from left to right correspond to different significances (index p or r) of the bits of the components of the input vector or of the weight vector.

In order to calculate the scalar product, voltages corresponding to the bits of the components of the input vector are applied to the row lines in iterations, wherein bits of a respective different significance (a position in the row) are used in each iteration. The values obtained by the analog-to-digital converter 26 after analog-to-digital conversion are weighted or shifted (by means of a bit shift operation) according to the significances, i.e., on the one hand the significance p of the bit of the components of the input vector applied to the row lines (according to the iteration or the column) and on the other hand the significance r of the bits of the components of the weight vector (according to the column line), and added up. An add-and-shift circuit 30 is provided for this purpose.

For each iteration (p=0, . . . , P) (i.e., for each bit position of the input vector), a result gₚ^{(t)} of the matrix circuit 20 is first calculated in the example shown, according to:

$${g}_{p}^{( t )} = {\sum }_{r = 0}^{q} ( {\sum }_{i = 0}^{k - 1} {f}_{pi}^{( t )} \cdot {w}_{ir} ) << r$$

The operator “<<” (shift operator) represents a shift operation by r bits in the direction of higher significance, i.e., corresponds to a multiplication by 2^{r}. k corresponds to the number of rows and can be less or equal to D. In general, the dimension D (i.e., the number of components fᵢ or wᵢ) of the input vector or weight vector is greater than the number k of maximally simultaneously activated rows (i.e., of rows to which a voltage according to the respective bits is applied simultaneously). In this case, the input vector and weight vector can be divided into portions; accordingly, subsets of the input vector are obtained. The calculation can then take place in a plurality of cycles, wherein only a subset or a portion of the components (at most k) of the input vector or weight vector is used in each cycle; in particular, only voltages corresponding to a single one of the subsets of input components are applied. The index t refers to a cycle of the calculation. The expression of this formula in parentheses (i.e., Σᵢfₚᵢ^{(t)}·wᵢᵣ) is determined by means of the matrix circuit 20 as an initial value of a column r, i.e., as an output value of an analog-to-digital converter, and is also referred to as a bit sum or bit sum with significances r and p. The bit sum can be regarded as a number of bits with value 1 in the AND operation of the bits of a particular significance p of the components of the input vector and of the bits of the significance r of the components of the weight vector, which takes place in the corresponding column of the matrix circuit. gₚ^{(t)} can be referred to as the scalar product summand of the significance p.

The weighting of the bit sums in the above sum takes place according to the significance r of the bits of the components of the weight vector. The weighting according to the significance p of the bits of the components of the input vector takes place in the sum below, in which the scalar product g is calculated. The weightings and sum formations can be carried out by means of circuits implementing bit shift operations or addition operations. Overall, the bit sums are weighted according to a respective (overall) significance, which is equal to the sum of the significance r of the bits of the components of the weight vector and the significance p of the bits of the components of the input vector (with which the respective bit sum has been determined).

The scalar product g results as the sum over the cycles and over the summands gₚ^{(t)} weighted according to their significance p:

$$g = {\sum }_{t = 0}^{D / k} {\sum }_{p = 0}^{P} {g}_{p}^{( t )} << p$$

For precise calculations, the number k of simultaneously activatable rows should be less than or equal to the precision or accuracy of the analog-to-digital converter, i.e., less than or equal to the maximum value m that the analog-to-digital converter 28 can recognize (i.e., an analog-to-digital converter with precision m can recognize the values 0, 1, . . . m). In the case of 3-bit analog-to-digital converters, the number k should be at most 7, for example; in the case of 4-bit analog-to-digital converters, the number k should be at most 15, for example.

Algorithms in the field of machine learning, e.g., neural networks, such as convolutional neural networks (CNN) or deep neural networks (DNN), which carry out multiplications of input vectors with weight matrices, i.e., calculate scalar products, can have a certain error tolerance with respect to inaccuracies of individual numerical values.

It is therefore provided to carry out an approximation in such a way that the number k of simultaneously activated or activatable rows is selected to be greater than the number of states that the analog-to-digital converters 28 can distinguish, and that the bit sums are limited to the precision or accuracy m (highest value) of the analog-to-digital converters. The precision denotes the highest value that the analog-to-digital converter can recognize or output (an analog-to-digital converter with b bits can, for example, distinguish whole-number values from 0 to m=2^{b}−1 or corresponding voltage steps and can output a corresponding binary number). A corresponding approximation ĝ for the scalar product is given by the following formulae:

$${\hat{g}}_{p}^{( t )} = {\sum }_{r = 0}^{q} min ( {\sum }_{i = 0}^{k - 1} {f}_{pi}^{( t )} \cdot {w}_{ir} , m ) << r$$

$$\hat{g} = {\sum }_{t = 0}^{D / k} {\sum }_{p = 0}^{P} {\hat{g}}_{p}^{( t )} << p$$

ĝₚ^{(t)}=(gₚ^{(t)}+ε) applies, wherein ε represents an approximation error.

Limited bit sums (with significance p,r) are thus determined, namely as min(Σᵢfₚᵢ^{(t)}·wᵢᵣ, m). “min” stands for the formation of the minimum.

This procedure can accelerate calculations (since the input vector and weight vector must be divided into fewer portions) and/or achieve a lower area consumption or energy consumption (since analog-to-digital converters with lower precision or fewer bits can be used).

The maximum activation number, i.e., the number k of maximally possible parallel activations can assume any whole-number positive value less than or equal to the dimension D of the vectors: k≤D. For example, for a 3-bit analog-to-digital converter, a set of possible values for k could be: {7, 14, 21}, wherein k₁=7 corresponds to an exact calculation (no approximation or minimum approximation level), and k₃=21 corresponds to a maximum approximation level, with a possible acceleration by a factor of 3. Accordingly, the throughput can be increased without changing the hardware.

In one embodiment, the at least one predetermined maximum activation number is greater than the precision of the respective analog-to-digital converter. As a result, analog-to-digital converters with relatively low precision or with relatively few bits can be used so that their area consumption or energy consumption is lower.

The maximum activation number is less than or equal to the number of rows of a single matrix circuit. In a calculation in a plurality of cycles, according to a plurality of subsets, respective ranges of the rows of a matrix circuit can correspond to the latter. The subsets can also be divided into different matrix circuits.

The set of possible values for k can in principle be selected as desired. Likewise, a different approximation level can be selected for different portions of the vectors and/or for different vectors, according to the selection of the number k of maximally possible parallel activations. This selection can in particular be based on an error tolerance analysis of the algorithm for which the scalar products are to be calculated. That is to say, for scalar products of the algorithm (i.e., scalar products occurring when the algorithm is carried out), a respective error tolerance level is determined first (e.g., as a numerical value in a particular value range), and an approximation level, i.e., a value for the number k of maximally possible parallel activations from the set of possible values for k according to the error tolerance level of the respective scalar product, is subsequently assigned to each scalar product and used for calculations. Furthermore, a respective error tolerance level can be determined for each portion for scalar products of portions of vectors, and an approximation level assigned to the respective error tolerance level can be used in the calculation of the scalar product of the portions.

The circuit shown in FIG. 2 can have a plurality of matrix circuits 22. A control circuit, which, for example, has a control unit 32, an activation unit 34 and a system buffer 36 can also be provided.

FIG. 4 shows a flowchart according to an exemplary embodiment of the approximative determination of a scalar product of an input vector with a weight vector, wherein input components of the input vector and weight components of the weight vector are each present in binary form (as bits).

In step 110, the memory cells are programmed according to bits of the weight components, wherein the bits with the same significance of at least a portion of the weight components are respectively programmed in memory cells of the same column.

In step 120, a bit sum determination is carried out for each of one or more subsets of the input components. In the sub-step 122, to a corresponding subset of the row lines, voltages are applied according to bits of the input components of the respective subset of the input components, which have the same significance. Sub-step 122 is carried out for all bits of the input components. A plurality of passes corresponding to the number of bits of an input component are thus carried out, wherein, in each pass, the bits of a particular significance are used (a respective different significance in different passes) and corresponding voltages are applied. In sub-step 124, limited bit sums are determined as the output value of the respective analog-to-digital converter (for each of the passes), which bit sums have significances corresponding to the respective column (i.e., the bits of the weight components) and to the significance of the bits to which the applied voltages correspond. The output value of the respective analog-to-digital converter is thus read out and used as a limited bit sum (with corresponding significances).

In step 130, a sum of the limited bit sums weighted according to their significance is determined. An approximation 135 for the scalar product is thus obtained.

Sponsorship and Support Information

The project that has led to this application was sponsored by the joint venture ECSEL (JU) within the framework of sponsorship agreement no. 826655. The JU is supported by the research and innovation program Horizon 2020 of the European Union and Belgium, France, Germany, the Netherlands and Switzerland.

What is claimed is:

1. A method for approximatively determining a scalar product of an input vector with a weight vector, wherein input components of the input vector and weight components of the weight vector are present in binary form, the method comprising:
proving a matrix circuit, which has memory cells which are arranged in a plurality of rows and a plurality of columns in a matrix-like manner, each of the memory cells respectively having a first and a second programmable memory state, wherein the matrix circuit has a row line for each of the rows and a column line for each of the columns, wherein each of the memory cells is connected to a row line and a column line and is configured to conduct an electrical current into the column line connected to the memory cell, wherein a current intensity of the electrical current depends on a voltage applied to the row line connected to the memory cell and on a memory state of the memory cell, wherein: (i) the current intensity is below a particular current intensity limit when a voltage of zero is applied and/or when the memory cell is in the first memory state, and (ii) the current intensity has a defined current intensity value when the applied voltage has a non-zero predetermined voltage value and the memory cell is in the first memory state; wherein each of the column lines is connected to a respective analog-to-digital converter which has a precision that is less than a number of memory cells in the column of the column line;
programming the memory cells according to respective bits of the weight components, wherein the respective bits with the same significance of at least a portion of the weight components are respectively programmed in memory cells of the same column;
for each of one or more subsets of the input components, carrying out a bit sum determination, wherein, to a corresponding subset of the row lines, voltages are applied according to bits with the same significance of the respective subset of the input components, and determining a limited bit sum as an output value of the respective analog-to-digital converter, the limited bit sum having significances corresponding to the significance of the respective column and to the significance of the bits to which the applied voltages correspond;
determining a sum of the limited bit sums weighted according to their significances to determine an approximation for the scalar product.

2. The method according to claim 1, wherein the one or more subsets of the input components are selected such that, for each subset, a number of the input components included therein is equal to or less than an assigned activation number of at least one predetermined maximum activation number.

3. The method according to claim 2, wherein the at least one predetermined maximum activation number is selected: (i) based on a predetermined approximation level of the scalar product and/or (ii) based on a plurality of predetermined approximation levels which are assigned to different portions of the scalar product.

4. The method according to claim 2, wherein the at least one predetermined maximum activation number is greater than the precision of the respective analog-to-digital converter.

5. The method according to claim 1, wherein, for each subset of the one or more subsets of the input components, a voltage of zero is applied during the bit sum determination to row lines that do not belong to the corresponding subset of the row lines.

6. The method according to claim 1, wherein, for each subset of the one or more subsets of the input components, a voltage of zero is applied during the bit sum determination to row lines that belong to the corresponding subset of the row lines when the respective bit has a value of 0, and the voltage with the predetermined voltage value is applied when the respective bit has a value of 1.

7. The method according to claim 1, wherein the one or more subsets of the input components are disjunct.

8. The method according to claim 1, wherein the one or more subsets of the input components are determined by dividing an entire set of the input components into the one or more subsets or by dividing the input vector into one or more sub-ranges.

9. The method according to claim 1, wherein approximations for scalar products of a plurality of different input vectors in each case with the weighting vector are determined without re-programming the memory cells between the determination for different input vectors.

10. A circuit, comprising:
at least one matrix circuit; and
at least one control circuit;
wherein the at least one matrix circuit has memory cells which are arranged in a plurality of rows and a plurality of columns in a matrix-like manner, each of the memory cells respectively having a first and a second memory state, wherein the matrix circuit has a row line for each of the rows and a column line for each of the columns, wherein each of memory cells is connected to a row line and a column line and is configured to conduct an electrical current into the column line connected to the memory cell, wherein a current intensity of the electrical current depends on a voltage applied to the row line connected to the memory cell and on a memory state of the memory cell, wherein: (i) the current intensity is below a particular current intensity limit if a voltage of zero is applied, and/or if the memory cell is in the first memory state, and (ii) the current intensity has a defined current intensity value if the applied voltage has a non-zero predetermined voltage value and the memory cell is in the first memory state;
wherein each column line of the column lines is connected to a respective analog-to-digital converter that has a precision that is less than a number of memory cells in the corresponding column of the column line; and
wherein the control circuit is configured to program the memory cells and to apply voltages to the row lines.

11. The circuit according to claim 10, wherein the control circuit is configured to approximatively determine a scalar product of an input vector with a weight vector, using the matrix circuit, wherein input components of the input vector and weight components of the weight vector are present in binary form:
programming the memory cells according to respective bits of the weight components, wherein the respective bits with the same significance of at least a portion of the weight components are respectively programmed in memory cells of the same column;
for each of one or more subsets of the input components, carrying out a bit sum determination, wherein, to a corresponding subset of the row lines, voltages are applied according to bits with the same significance of the respective subset of the input components, and determining a limited bit sum as an output value of the respective analog-to-digital converter, the limited bit sum having significances corresponding to the significance of the respective column and to the significance of the bits to which the applied voltages correspond; and
determining a sum of the limited bit sums weighted according to their significances to determine an approximation for the scalar product.

12. The circuit according to claim 10, wherein the precision indicates how many values the analog-to-digital converter can distinguish.

13. The circuit according to claim 10, wherein each column line is connected to the respective analog-to-digital converter via a current-voltage converter, the current-voltage converter including a transimpedance amplifier.

14. The circuit according to claim 10, further comprising at least one add-and-shift circuit as part of the at least one matrix circuit.
